(19) United States
(12) Patent Application Publication
(10) Pub. No.: US 2022/0123939 A1
(43) Pub. Date: Apr. 21, 2022

(54) Relational Product Authentication System

(71) Applicant: EVRYTHNG Ltd, London (GB)

(72) Inventors: Dominique Guinard, Yverdon-les-Bains (CH); Shmuel Silverman, Novato, CA (US)

(73) Assignee: EVRYTHNG Ltd, London (GB)

(21) Appl. No.: 17/504,457

(22) Filed: Oct. 18, 2021

Related U.S. Application Data
(60) Provisional application No. 63/094,150, filed on Oct. 20, 2020.

(51) Int. Cl. H04L 9/32

(52) U.S. Cl. CPC H04L 9/3226; G06Q 30/0185

(57) ABSTRACT

A computer system may receive, from an electronic device, an identifier of an object or a label associated with the object. Then, the computer system may determine an authentication score of the object based at least in part on authentication information corresponding to a level in a hierarchical arrangement of levels or operations in a supply or a fulfillment chain of the object. Moreover, in general, the authentication information for the level in the hierarchical arrangement may be based at least in part on container or packaging information of containers or packages in at least a subset of levels below the level in the hierarchical arrangement and second container or packaging information of a given container or a given package in the level. Next, the computer system may provide, to the electronic device, information that specifies whether the object is authentic based at least in part on the authentication score.

### CROSS REFERENCE TO RELATED APPLICATIONS

This application claims priority under 35 U.S.C. 119(e) to U.S. Provisional Application Ser. No. 63/094,150, entitled “Relational Product Authentication System,” by Dominique Guinard, et al., filed on Oct. 20, 2020, the contents of which are herein incorporated by reference.

### FIELD

The described embodiments relate generally to techniques for authenticating a product or a service. Notably, the described embodiments relate to techniques for authentication and content tracing in a zero-trust environment based at least in part on the unique dynamic relationships between items and containers (such as packaging materials).

### BACKGROUND

It is often easy to duplicate the original information printed or marked on a box or package for a product (which is sometimes referred to as ‘goods’). Then, by including new or fake content in the duplicated box, a fraudulent or counterfeit product can be sold as if it is an authentic product.

Moreover, even when the content on the original box or package is augmented, unless a receiver (such as the intended recipient of the goods) performs a detailed analysis, it is typically difficult to use such augmented to content trace, monitor and/or detect a counterfeit product. Furthermore, when boxes or packages are included in a more complicated container box (such as larger boxes, pallets and/or containers), the overall complexity of authentication is increased. This is complicates supply-chain management, and is frustrating to manufacturers, fulfillment personnel, supply-chain staff and receivers or customers.

### SUMMARY

In a first group of embodiments, computer system that provides information that specifies whether an object is authentic is described. This computer system may include: an interface circuit that communicates with an electronic device (which may be remotely located from the computer system); a processor; and memory that stores program instructions and a data structure for objects. The data structure includes, for a given object, authentication information corresponding to hierarchical arrangement of levels or operations in a supply or a fulfillment chain of the given object. Moreover, other than terminal levels in the hierarchical arrangement, the authentication information for a given level in the hierarchical arrangement is based at least in part on container or packaging information of containers or packages in at least a subset of levels below the given level in the hierarchical arrangement and second container or packaging information of a given container or a given package in the given level. During operation, the computer system receives, at the interface circuit and associated with the electronic device, an identifier of an object or a label associated with the object. Then, the computer system determines an authentication score of the object based at least in part on the authentication information for a level in the hierarchical arrangement associated with the identifier. Next, the computer system provides, from the interface circuit and addressed to the electronic device, the information that specifies whether the object is authentic based at least in part on the authentication score.

Note that the levels in the hierarchical arrangement may correspond to an ordered sequence of operations in the supply or a fulfillment chain, and the subset of levels may be prior to the given level in the ordered sequence or subsequent to the given level in the ordered sequence.

Moreover, the computer system may: receive, at the interface circuit and associated with a second electronic device, update information corresponding to another operation in the ordered sequence of operations; and dynamically modify the data structure based at least in part on the update information.

Furthermore, the hierarchical arrangement may include a Merkle tree with the levels, where there are M levels and N subsets of levels in the Merkle tree, and M and N are non-zero integers.

Additionally, given container or packaging information may include content associated with the given object and/or a context associated with the given object.

In some embodiments, the given container or the packaging information may include: a number of instances of the given object in the given container or the given package; an absolute or relative number associated with the given object; physical information associated with the given object; chemical information associated with the given object; biological information associated with the given object; environmental information associated with the given object; and/or color information associated with the given object.

Note that the authentication information may include a hash function that uses as inputs the container or packaging information of at least the subset of levels below the given level in the hierarchical arrangement.

Moreover, the authentication information may be encrypted. In some embodiments, different levels in the hierarchical arrangement may use different encryption keys.

Furthermore, for the given level, the authentication information may be based at least in part on a customer or intended destination of the given container or the given package.

Additionally, the identifier may be encrypted.

In some embodiments, a relationship between the given level and the subset of daughter levels in the hierarchy may not be unique to the given object.

Note that the objects may include products.

Moreover, the authentication information may be unique in the hierarchical arrangement.

Another embodiment provides a computer-readable storage medium for use with the computer system. When executed by the computer system, this computer-readable storage medium causes the computer system to perform at least some of the aforementioned operations.

Another embodiment provides a method that may be performed by the computer system. This method includes at least some of the aforementioned operations.

In a second group of embodiments, an electronic device that receives information that specifies whether an object is authentic is described. This electronic device may include: an interface circuit that communicates with a computer system (which may be remotely located from the electronic device); a processor; and memory that stores program instructions. During operation, the electronic device provides, from the interface circuit and addressed to the computer system, an identifier of an object or a label associated with the object. Then, the electronic device receives, at the interface circuit and associated with the computer system, the information that specifies whether the object is authentic based at least in part on an authentication score. Note that the authentication score of the object is based at least in part on authentication information for the object and corresponding to two or more levels in a hierarchical arrangement of levels or operations in a supply or a fulfillment chain of the object. For example, the authentication information may be based at least in part on container or packaging information of containers or packages in at least a subset of levels below a current level in the hierarchical arrangement and second container or packaging information of a given container or a given package in the current level.

Another embodiment provides a computer-readable storage medium for use with the electronic device. When executed by the electronic device, this computer-readable storage medium causes the electronic device to perform at least some of the aforementioned operations.

Another embodiment provides a method that may be performed by the electronic device. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for providing information that specifies whether an object is authentic using a computer system of FIG. 1 in accordance with an embodiment of the present disclosure.

FIG. 3 is a flow diagram illustrating an example of a method for receiving information that specifies whether an object is authentic using an electronic device of FIG. 1 in accordance with an embodiment of the present disclosure.

FIG. 4 is a drawing illustrating an example of communication among electronic devices in FIG. 1 in accordance with an embodiment of the present disclosure.

FIG. 5 is a drawing illustrating an example of aggregation during the supply of goods from manufacturing to a destination in accordance with an embodiment of the present disclosure.

FIG. 6 is a drawing illustrating an example of disaggregation of goods in accordance with an embodiment of the present disclosure.

FIG. 7 is a drawing illustrating an example of reaggregation of goods in accordance with an embodiment of the present disclosure.

FIG. 8 is a drawing illustrating an example of a binary Merkle Tree (MT) in accordance with an embodiment of the present disclosure.

FIG. 9 is a drawing illustrating examples of generalized tree relational structures in accordance with an embodiment of the present disclosure.

FIG. 10 is a drawing illustrating an example of mapping a problem onto a generalized MT in accordance with an embodiment of the present disclosure.

FIG. 11 is a drawing illustrating an example of a data model in accordance with an embodiment of the present disclosure.

FIG. 12 is a drawing illustrating an example of a relationship between a data model and hash codes in accordance with an embodiment of the present disclosure.

FIG. 13 is a drawing illustrating an example of an aggregation activation technique in accordance with an embodiment of the present disclosure.

FIG. 14 is a drawing illustrating an example of a disaggregation technique using codes, content and/or other information in accordance with an embodiment of the present disclosure.

FIG. 15 is a drawing illustrating an example of a disaggregation technique using an MT hash to unravel content dependencies in accordance with an embodiment of the present disclosure.

FIG. 16 is a drawing illustrating an example of scanning and authentication based at least in part on box code, color image and/or context information in accordance with an embodiment of the present disclosure.

FIG. 17 is a drawing illustrating an example of an aggregation and distribution technique in accordance with an embodiment of the present disclosure.

FIG. 18 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

During operation, a computer system (which may include one or more computers) may receive, from an electronic device, an identifier of an object or a label associated with the object. Then, the computer system may determine an authentication score of the object based at least in part on authentication information for the object and corresponding to a level in a hierarchical arrangement of levels or operations in a supply or a fulfillment chain of the object. Moreover, other than terminal levels in the hierarchical arrangement, the authentication information for the level in the hierarchical arrangement may be based at least in part on container or packaging information of containers or packages in at least a subset of levels below the level in the hierarchical arrangement and second container or packaging information of a given container or a given package in the level. Next, the computer system may provide, to the electronic device, information that specifies whether the object is authentic based at least in part on the authentication score.

By providing the authentication score, these authentication techniques may reduce or eliminate instances of counterfeit or fraudulent products. Notably, the counterfeit or fraudulent products may be addressed by leveraging the relationships between items, the relationships between items and containers (or packaging material), and/or the relationships between different containers that are available in the supply or fulfillment chains of products. Moreover, the authentication techniques may avoid the need to augment content on boxes or packaging material, such as the use of expensive identifiers or tags. Furthermore, by reducing or eliminating counterfeit or fraudulent products and/or unauthorized distribution of the products, the authentication techniques may facilitate insurance instruments for products. Consequently, the authentication techniques may increase the trustworthiness of products and the reliability of a variety of marketplaces (such as online marketplaces) without increasing the complexity of boxes or packaging material, and without making authentication more complicated and time-consuming. Therefore, the authentication techniques may simplify supply-chain management (e.g., by reducing confusion, errors and/or malicious actions, as well as the associated expenses), may be easier to use for manufacturers, fulfillment personnel, supply-chain staff and receivers or customers, and thus may result in increased commercial activity.

In some embodiments, at least a portion of the authentication techniques may be implemented in a distributed or decentralized manner. Alternatively, in some embodiments, at least a portion of the authentication techniques may be implemented in a centralized manner.

In the discussion that follows, electronic devices may communicate packets or frames with wired and/or wireless networks (e.g., via access points, radio nodes and/or base stations) in accordance with a wired communication protocol (such as an Institute of Electrical and Electronics Engineers or IEEE 802.3 standard, which is sometimes referred to as ‘Ethernet’, or another type of wired interface) and/or a wireless communication protocol, such as: an IEEE 802.11 standard (which is sometimes referred to as ‘Wi-Fi,’ from the Wi-Fi Alliance of Austin, Tex.), Bluetooth (from the Bluetooth Special Interest Group of Kirkland, Wash.), a cellular-telephone communication protocol (such as 2G, 3G, 4G, 5G, Long Term Evolution or LTE, another cellular-telephone communication protocol, etc.) and/or another type of wireless interface. In the discussion that follows, Wi-Fi, a cellular-telephone communication protocol and Ethernet are used as an illustrative example. However, a wide variety of communication protocols may be used. Note that the wireless communication may occur in a variety of frequency bands, such as: a cellular-telephone communication band, a frequency band associated with a Citizens Band Radio Service, a Wi-Fi frequency band (such as a 2.4 GHz, a 5 GHz, a 6 GHz and/or a 60 GHz frequency band), etc.

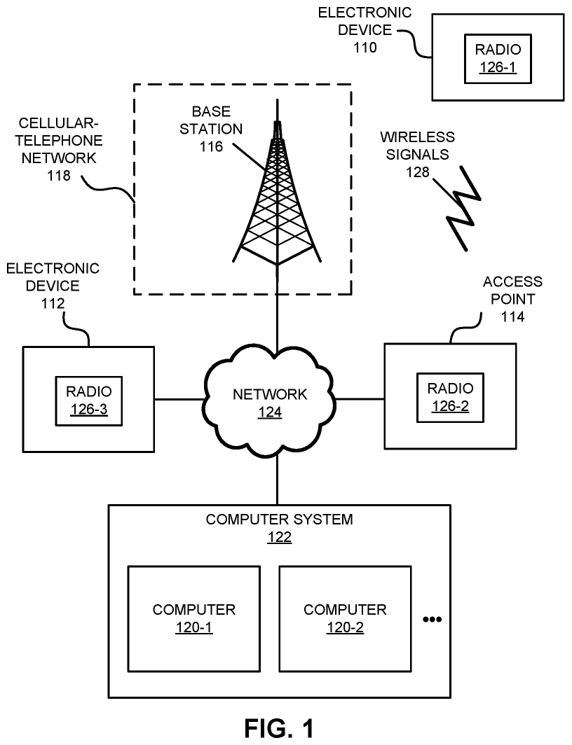

FIG. 1 presents a block diagram illustrating an example of communication among one or more of electronic devices 110 and 112 (such as a cellular telephone, a computer, etc., and which are sometimes referred to as ‘clients’), access point 114, base station 116 in cellular-telephone network 118, and one or more computers 120 in computer system 122 in accordance with some embodiments. Access point 114 and base station 116 may communicate with computer system 122 via network 124 (such as the Internet) using wireless and/or wired communication (such as by using Ethernet or a communication protocol that is compatible with Ethernet), and may communicate with electronic device 110 using wireless communication (Wi-Fi and a cellular-telephone communication protocol, respectively). Note that access point 114 may include a physical access point and/or a virtual access point that is implemented in software in an environment of an electronic device or a computer. In addition, access point 114 and/or base station 116 may communicate with electronic devices 110 using wireless communication, while electronic device 112 may communicate with computer system 122 via network 124.

While not shown in FIG. 1, the wired and/or wireless communication with electronic devices 110 and/or 112 may further occur via an intranet, a mesh network, point-to-point connections, etc., and may involve one or more routers and/or switches. Furthermore, the wireless communication may involve: transmitting advertising frames on wireless channels, detecting one another by scanning wireless channels, establishing connections (for example, by transmitting association or attach requests), and/or transmitting and receiving packets or frames (which may include the association requests and/or additional information as payloads). In some embodiments, the wired and/or wireless communication in FIG. 1 also involves the use of dedicated connections, such as via a peer-to-peer (P2P) communication technique.

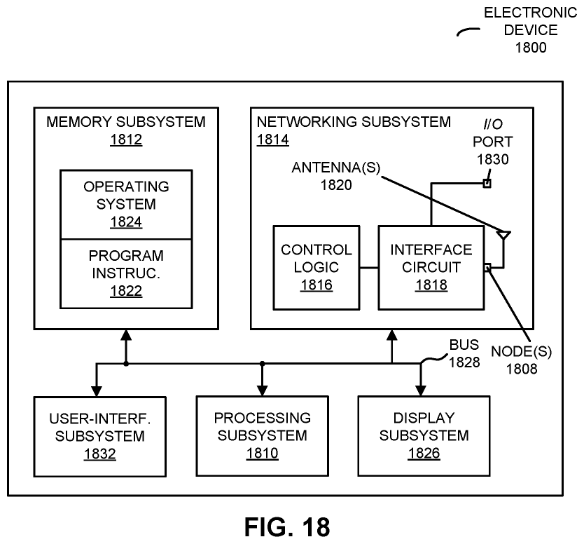

As described further below with reference to FIG. 18, electronic device 110, electronic device 112, access point 114, base station 116, and/or computers 120 may include subsystems, such as a networking subsystem, a memory subsystem and a processor subsystem. In addition, electronic device 110, access point 114 and base station 116 may include radios 126 in the networking subsystems. More generally, electronic device 110, electronic device 112 and access point 114 can include (or can be included within) any electronic devices with the networking subsystems that enable electronic device 110 and access point 114 to communicate with each other using wireless and/or wired communication. This wireless communication can comprise transmitting advertisements on wireless channels to enable access point 114 and/or electronic device 110 to make initial contact or detect each other, followed by exchanging subsequent data/management frames (such as association requests and responses) to establish a connection, configure security options (e.g., Internet Protocol Security), transmit and receive packets or frames via the connection, etc. Note that while instances of radios 126 are shown in electronic device 110 and access point 114, one or more of these instances may be different from the other instances of radios 126.

As can be seen in FIG. 1, wireless signals 128 (represented by a jagged line) are transmitted from radio 126-1 in electronic device 110. These wireless signals may be received by radio 126-2 in access point 114. Notably, electronic device 110 may transmit packets or frames. In turn, these packets or frames may be received by access point 114. Moreover, access point 114 may allow electronic device 110 to communicate with other electronic devices, computers and/or servers via network 124.

Note that the communication among components in FIG. 1 may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

In the described embodiments processing a packet or frame in electronic device 110 and/or access point 114 includes: receiving signals (such as wireless signals 128) with the packet or frame; decoding/extracting the packet or frame from received wireless signals 128 to acquire the packet or frame; and processing the packet or frame to determine information contained in the packet or frame.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

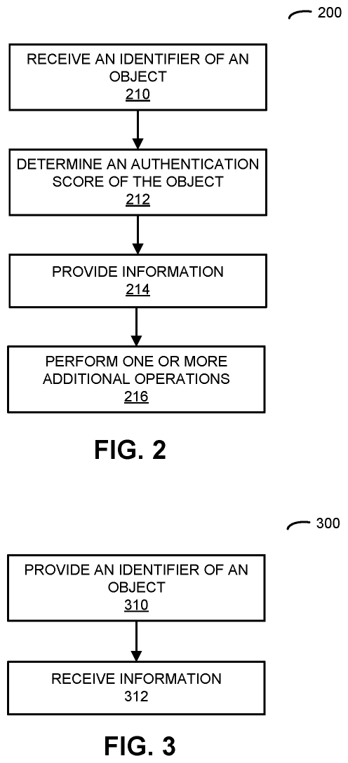

As discussed previously, it is often difficult to authenticate products in a simple and efficient manner. In order to address these problems, as described further below with reference to FIGS. 2-17, the authentication techniques may be used to provide different embodiments. For example, the authentication techniques may be used to provide authentication as a service. Notably, an electronic device (such as electronic device 110 or 112) may provide to computer system 122 (such as computer 120-1) an identifier of an object (such as a product) or a label associated with the object (such as an image of the label). In the discussion that follows, electronic device 110 is used to illustrate the authentication techniques. Electronic device 110 may have obtained the identifier by scanning or acquiring an image of the identifier or the label that includes the identifier. In some embodiments, electronic device 110 may obtain the identifier by performing an image-processing or an image-analysis technique on the label or an image of the label. This image-processing or image-analysis technique may include: an edge or a line-segment detector, a texture-based feature detector, a texture-less feature detector, a scale invariant feature transform (SIFT)-like object-detector, a speed-up robust-features (SURF) detector, a binary-descriptor (such as ORB) detector, a binary robust invariant scalable keypoints (BRISK) detector, a fast retinal keypoint (FREAK) detector, a binary robust independent elementary features (BRIEF) detector, a features from accelerated segment test (FAST) detector, and/or another image-processing or image-analysis technique. Alternatively or additionally, in some embodiments the image may be analyzed using a pre-trained machine-learning model. Note that the pre-trained machine-learning model may have been trained using a machine-learning technique, such as a supervised-learning technique. The supervised-learning technique may include: a classification and regression tree, a support vector machine (SVM), linear regression, nonlinear regression, logistic regression, least absolute shrinkage and selection operator (LASSO), ridge regression, a random forest, and/or another type of supervised-learning technique. In some embodiments, the pre-trained machine-learning model may include a pre-trained neural network, such as a convolutional neural network or a recurrent neural network.

Furthermore, the identifier may be encrypted using an encryption key that is shared by electronic device 110 and computer system 122. In some embodiments, the identifier may include or may be compatible with: a global standards 1 (GS1) digital link, a global trade item number (GTIN), a serial shipping container (SSCC), a serialized global trade item number (SGTIN), an European article number code (EAN), a universal product codes (UPC), an electronic product code (EPC), a global location number (GLN), an international standard book identifier (ISBN), a global returnable asset identifier (GRAI), a global coupon number (GCN), an Amazon standard identification number (ASIN), a global shipment identification number (GSIN), a universally unique identifier (UUID), a global document type identifier (GDTY), a globally unique identifier (GUID), an Eddystone UID or EID, an international mobile equipment identity (IMEI), an eSIM identifier, a pharmaceutical product identifier (PhPID), a serial number, a blockchain address, a blockchain transaction identifier, a hash table, a blockchain token, an ERC721 token, a non-fungible token, and/or a public key. In some embodiments, the identifier may be a random or a pseudo-random number.

Computer 120-1 may receive the identifier. Then, computer 120-1 may access (e.g., in local memory and/or remotely located memory associated with computer system 122) information associated with a data structure for objects. This data structure may include, for a given object, authentication information corresponding to hierarchical arrangement of levels or operations in a supply or a fulfillment chain of the given object. Moreover, other than terminal levels in the hierarchical arrangement, the authentication information for a given level in the hierarchical arrangement may be based at least in part on container or packaging information of containers or packages in at least a subset of levels below the given level in the hierarchical arrangement and second container or packaging information of a given container or a given package in the given level. Note that the supply or fulfillment chain may include one or more instances of packaging the object. For example, the object may be repacked or transferred into different physical containers during the supply or fulfillment chain.

The data structure may have been previously provided to computer system 122 (e.g., by a manufacturer of the given object) and/or may have been acquired by computer system 122 as the objects transit their supply or fulfillment chains (such as from electronic devices, e.g., electronic device 112, located in warehouse, transportation hubs, vehicles, supply-chain fulfillment centers and/or retail establishments). For example, the levels in the hierarchical arrangement may correspond to an ordered sequence of operations in the supply or a fulfillment chain, and the subset of levels may be prior to the given level in the ordered sequence or subsequent to the given level in the ordered sequence. In these embodiments, computer 120-1 may: receive, e.g., from electronic device 112, update information corresponding to another operation in the ordered sequence of operations in the supply or fulfillment chain; and dynamically modify the data structure based at least in part on the update information.

Moreover, the hierarchical arrangement may include a Merkle tree with the levels, where there are M levels and N subsets of levels in the Merkle tree, and M and N are non-zero integers.

Furthermore, given container or packaging information may include content associated with the given object and/or a context associated with the given object. In some embodiments, the given container or the packaging information may include: a number of instances of the given object in the given container or the given package; an absolute or relative number associated with the given object (which may include Fuzzy logic values and/or a number related to a position of the given object in a level in a hierarchy of levels); physical information associated with the given object; chemical information associated with the given object; biological information associated with the given object; environmental information associated with the given object; and/or color information associated with the given object or its arrangement in a level in a hierarchy of levels.

Note that the authentication information may include a hash function that uses as inputs the container or packaging information of at least the subset of levels below the given level in the hierarchical arrangement. Moreover, the authentication information may be encrypted. For example, different levels in the hierarchical arrangement may use different encryption keys. Furthermore, for the given level, the authentication information may be based at least in part on a customer or intended destination of the given container or the given package. Additionally, the authentication information may be unique in the hierarchical arrangement. However, in some embodiments, a relationship between the given level and the subset of daughter levels in the hierarchy may not be unique to the given object.

Using the information, computer 120-1 may determine an authentication score of the object based at least in part on the authentication information for a level in the hierarchical arrangement associated with the identifier. Next, computer 120-1 may provide, to electronic device 110, second information that specifies whether the object is authentic based at least in part on the authentication score.

Moreover, electronic device 110 may receive the second information that specifies whether the object is authentic based at least in part on an authentication score. This second information may be provided to a user of electronic device 110, e.g., on a display. For example, the supply or fulfillment chain may include display of the object in a document at a location in a network (such as a web page or a website) and the authentication score may confirm the authenticity of a displayed instance of the object. Moreover, the authentication score may confirm that the object is unchanged up to the current level in the supply or fulfillment chain.

In these ways, computer system 122 may provide end-to-end authentication of the object (such as a product or a service) in an online or a physical supply or fulfillment chain, or in a marketplace. Thus, the authentication techniques may ensure or guarantee the authenticity of a product. Consequently, the authentication techniques may reduce or eliminate fraud and, thus, may reduce the associated costs. Therefore, the authentication techniques may enhance trust in the instances of the object, and in marketplaces that sell or conduct commercial transactions that include or involve the object.

While the preceding embodiments illustrated the authentication techniques being implemented via a cloud-based computer system 122, in other embodiments at least some of the aforementioned operations may be performed locally on, e.g., electronic device 110 or 112. Thus, operations in the authentication techniques may be performed locally or remotely.

We now describe embodiments of a method. FIG. 2 presents a flow diagram illustrating an example of a method 200 for providing information that specifies whether an object is authentic using a computer system, such as one or more computers 120 in computer system 122 (FIG. 1). During operation, the computer system may receive, associated with an electronic device, an identifier of an object (operation 210) or a label associated with the object. Note that the object may include a product.

Then, the computer system may determine an authentication score of the object (operation 212) based at least in part on authentication information for the object and corresponding to a level in a hierarchical arrangement of levels or operations in a supply or a fulfillment chain of the object. Moreover, other than terminal levels in the hierarchical arrangement, the authentication information for the level in the hierarchical arrangement may be based at least in part on container or packaging information of containers or packages in at least a subset of levels below the level in the hierarchical arrangement and second container or packaging information of a given container or a given package in the level.

Note that the levels in the hierarchical arrangement may correspond to an ordered sequence of operations in the supply or a fulfillment chain, and the subset of levels may be prior to the given level in the ordered sequence or subsequent to the given level in the ordered sequence. Furthermore, the hierarchical arrangement may include a Merkle tree with the levels, where there are M levels and N subsets of levels in the Merkle tree, and M and N are non-zero integers. In some embodiments, a relationship between the given level and the subset of daughter levels in the hierarchy may not be unique to the given object.

Additionally, the given container or the packaging information may include content associated with the given object and/or a context associated with the given object. In some embodiments, the given container or the packaging information may include: a number of instances of the given object in the given container or the given package; an absolute or relative number associated with the given object; physical information associated with the given object; chemical information associated with the given object; biological information associated with the given object; environmental information associated with the given object; and/or color information associated with the given object.

Moreover, the authentication information may include a hash function that uses as inputs the container or packaging information of at least the subset of levels below the given level in the hierarchical arrangement. Furthermore, the authentication information may be encrypted. For example, different levels in the hierarchical arrangement may use different encryption keys. Additionally, for the given level, the authentication information may be based at least in part on a customer or intended destination of the given container or the given package. In some embodiments, the authentication information may be unique in the hierarchical arrangement.

Next, the computer system may provide, addressed to the electronic device, the information (operation 214) that specifies whether the object is authentic based at least in part on the authentication score.

In some embodiments, the computer system performs one or more optional additional operations (operation 216). For example, the computer system may: receive, at the interface circuit and associated with a second electronic device, update information corresponding to another operation in the ordered sequence of operations; and dynamically modify the data structure based at least in part on the update information.

Moreover, the identifier may be encrypted. In these embodiments, the computer system may decrypt the encrypted identifier before determining the authentication score of the object (operation 212).

FIG. 3 presents a flow diagram illustrating an example of a method 300 for receiving information that specifies whether an object is authentic using an electronic device, such as electronic device 110 or 112 (FIG. 1). During operation, the electronic device may provide, addressed to a computer system, an identifier of an object (operation 310) or a label associated with the object. Then, the electronic device may receive, associated with the computer system, the information (operation 312) that specifies whether the object is authentic based at least in part on an authentication score. Note that the authentication score of the object may be based at least in part on authentication information for the object and corresponding to two or more levels in a hierarchical arrangement of levels or operations in a supply or a fulfillment chain of the object. For example, the authentication information may be based at least in part on container or packaging information of containers or packages in at least a subset of levels below a current level in the hierarchical arrangement and second container or packaging information of a given container or a given package in the current level.

In some embodiments of method 200 (FIG. 2) and/or 300, there may be additional or fewer operations. Furthermore, the order of the operations may be changed, there may be different operations and/or two or more operations may be combined into a single operation.

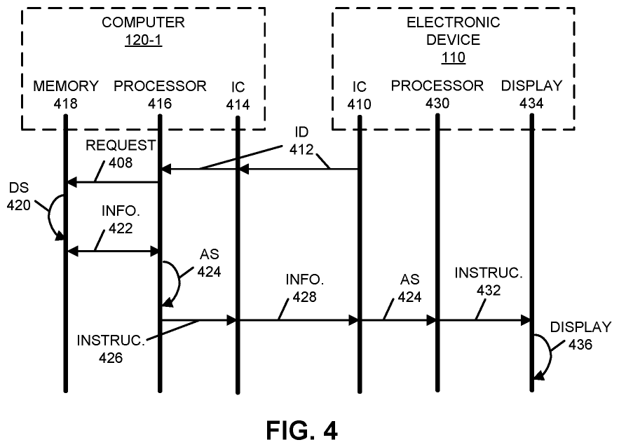

FIG. 4 presents a drawing illustrating an example of communication among electronic device 110 and computer 120-1. During the authentication techniques, an interface circuit (IC) 410 in electronic device 110 may provide, addressed to computer 120-1, an identifier (ID) 412 of an object.

After receiving identifier 412, an interface circuit 414 in computer 120-1 may provide identifier 412 to a processor 416 in computer 120-1. In response, processor 416 may request 408 information 422, in memory 418 in computer 120-1, which is associated with a data structure (DS) 420 for objects. This data structure may include, for a given object, authentication information corresponding to hierarchical arrangement of levels or operations in a supply or a fulfillment chain of the given object. Moreover, other than terminal levels in the hierarchical arrangement, the authentication information for a given level in the hierarchical arrangement may be based at least in part on container or packaging information of containers or packages in at least a subset of levels below the given level in the hierarchical arrangement and second container or packaging information of a given container or a given package in the given level.

Then, processor 416 may determine an authentication score (AS) 424 of the object based at least in part on the authentication information for the object. For example, processor 416 may determine the authentication score using a pretrained machine-learning model, such as a pretrained neural network. Alternatively or additionally, determining the authentication score may include comparing the identifier to a corresponding value in the data structure, such as a stored identifier or a stored value corresponding to the identifier (such as a hash value corresponding to the identifier and a particular hash function for a level in the hierarchy associated with a position in a supply or fulfillment chain).

Moreover, processor 416 may provide an instruction 426 to interface circuit 414 to provide, addressed to electronic device 110, information 428 that specifies whether the object is authentic based at least in part on the authentication score 424. After receiving information 428, interface circuit 410 may provide the authentication score 424 to processor 430 in electronic device 110. Processor 430 may instruct 432 a display 434 in electronic device 110 to display 436 or present the authentication score 424. More generally, electronic device 110 may provide feedback (such as sound, synthetic speech, an image, video, etc.) to a user, which corresponds to the authentication score 424.

While FIG. 4 illustrates communication between components using unidirectional or bidirectional communication with lines having single arrows or double arrows, in general the communication in a given operation in these figures may involve unidirectional or bidirectional communication.

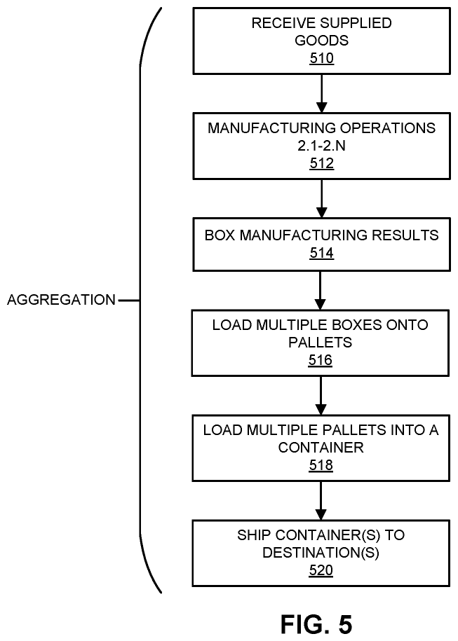

We now further describe the authentication techniques. During a supply or fulfillment chain, there may be at least three processes that can occur: aggregation, disaggregation, and reaggregation. Challenges associated with some or all of these processes may be solved using these different aggregation tools. Notably, one or more fulfillment workers and/or a computer system may make sure that a product that is received at any operation is also what was shipped at any of the operations shown below with references to FIGS. 5-7. For example, that the product was not switched or modified during shipping or receiving.

Moreover, one or more fulfillment workers and/or a computer system may capture the relationships between containers or packaging material and contents at every operation in the aggregation and disaggregation processes. This may also ensure the relationships are kept or maintained and, therefore, making it harder for counterfeiters to change these relationships and contents.

Furthermore, one or more fulfillment workers and/or a computer system may preventing the use of forgery techniques, such as ‘changing the contents while maintaining the labels.’

Additionally, one or more fulfillment workers and/or a computer system may enable authentication of bulk-based products.

In some embodiments, one or more fulfillment workers and/or a computer system may provide full traceability of a product to its sources, with and without detailed content labeling. Note that batch-level serialization may be sufficient for the authentication process to be successful using one or more of these approaches or tools.

### Aggregation

Aggregation occurs during the manufacturing and shipping process. Notably, during aggregation, raw materials, items and containers may be used to form the finished packed product. For example, raw materials may become items packaged in a box, which is: loaded onto a pallet, into a container, and/or shipped to a destination. Note that sometimes aggregation may be distinguished from transformation. Transformation relates to the raw materials becoming a finished product, and aggregation to the grouping of finished products into boxes, pallets, containers, etc. For the sake of simplicity, in the present discussion we refer to both processes as ‘aggregation.’

An information system (IS) is a computer (local, cloud-based and/or distributed) that records all aggregation operations is shown in FIG. 5, which presents a drawing illustrating an example of aggregation during the supply of goods from manufacturing to a destination. Aggregation begins in a factory where manufacturing (or assembly/processing) may receive supplied goods (operation 510). This could be from multiple sources for identical or nonidentical materials, or could also be in bulk from multiple sources. Then, multiple manufacturing operations (2.1 to 2.N) may occur with multiple manufacturing facilities (operation 512). Moreover, the manufacturing results may be boxed (operation 514). Next, multiple boxes may be loaded onto pallets (operation 516). Furthermore, multiple pallets may be loaded into a container (operation 518). Additionally, the container(s) may be shipped to their destination(s) (operation 520).

Existing approaches try to solve some of the issues during aggregation by provisioning a unique identifier (ID) to each part and then focusing on preventing this identifier from being copied or duplicated. These techniques lead to extremely complicated and disjointed systems based at least in part on a core assumption that the identifier cannot be duplicated. An example that existing approaches fail to solve is handling bulk goods of any kind, such as simple food supply goods or drugs being shipped to a pharmacy.

There is a need to solve these authentication problems with a general system that is not based at least in part on the assumption that one can uniquely code every part and subpart of the shipping goods, but is based at least in part on different authentication techniques. In the present discussion, the disclosed computer system assumes that every code or identifier is a forgery and cannot be trusted (a zero-trust system). Moreover, the complexity of relationships within every product and process provides an independent behavioral-based measurement of uniqueness relative to the object that is being assessed for authenticity. Consequently, we no longer need to trust codes (or other techniques used in existing approaches), but take the entire process into account.

### Disaggregation

Disaggregation occurs throughout the supply-chain process in order to verify if the received goods are authentic. Notably, goods are typically disaggregated from the containers or packaging material and their identifiers are scanned to check that the disaggregation is correct. For example, a fulfillment work may scan a box and scan a product and ensure the product is in the box the information system says it should be in.

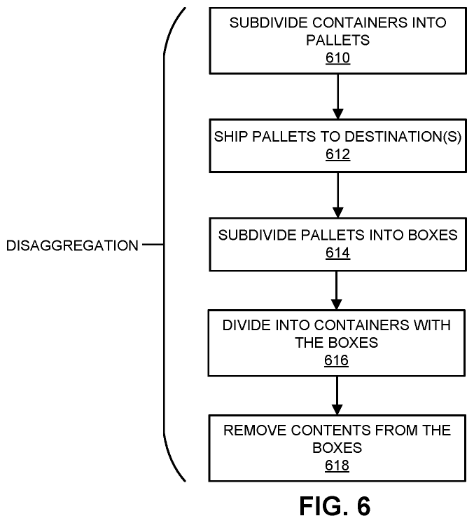

As shown in FIG. 6, which presents a drawing illustrating an example of disaggregation of goods, the disaggregation process begins with subdividing contents of multiple containers into multiple pallets (operation 610), which may be shipped to multiple destinations (operation 612). Then, the multiple pallets may be subdivided into multiple boxes (operation 614) that may contain multiple manufacturing final goods. Next, the containers within the boxes are divided (operation 616) and contents are removed from the boxes (operation 618).

### Reaggregation

Note that the described aggregation and disaggregation operations are illustrations. In other embodiments, there may be variations on either or both of these operations. For example, there are embodiments where there is partial disaggregation followed by aggregation that may be captured under reaggregation. In this process, the same information system may be used to record the aggregation, disaggregation operations, as well as the combination of the aggregations and disaggregation tools used in the process of aggregation/disaggregation and reaggregation.

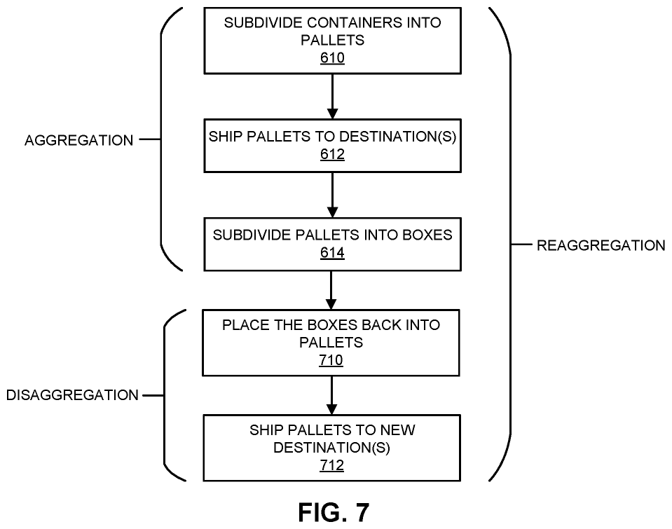

As shown in FIG. 7, which presents a drawing illustrating an example of reaggregation of goods, operations 610-614 is the disaggregation described in FIG. 6 while operations 710 and 712 are the aggregation. Notably, the containers may be subdivided into pallets (operation 610), the pallets may be shipped to destinations (operation 612), and the pallets may be subdivided into boxes (operation 614). Then, during aggregation, the boxes may be placed back into pallets (operation 710) and the pallets may be shipped to new destination(s) (operation 712). For example, during reaggregation, items may be placed into new packaging. Notably, in supply chains, pallets may be broken down and ‘re-palletized’ for further distribution,′ so a new relationship may need to be built at that point in the data structure used by the computer system.

### Merkle Tree (MT)

An MT, also known as a hash tree, is an example of a type of data structure that can be used to reflect aggregated relationship and hierarchy information associated with codes (which may be the same as or related to identifiers of objects, such as products). MTs are a hash-based data structure that is the generalization of the hash list. Although we are using this form of information as an example, the information derived in this structure can be kept in other forms, such as: metadata, database, and/or other data structures. In the discussion that follows, a data structure is sometimes referred to as a ‘database.’ However, database should be understood to include a wide variety of data structures, include: a hierarchical database, a relational database, a database having a schema, a flat database, a hash table, a look-up table, a data structure without a schema, and/or another type of database or data structure. Therefore, the present disclosure can be independent of these embodiments and may take many forms.

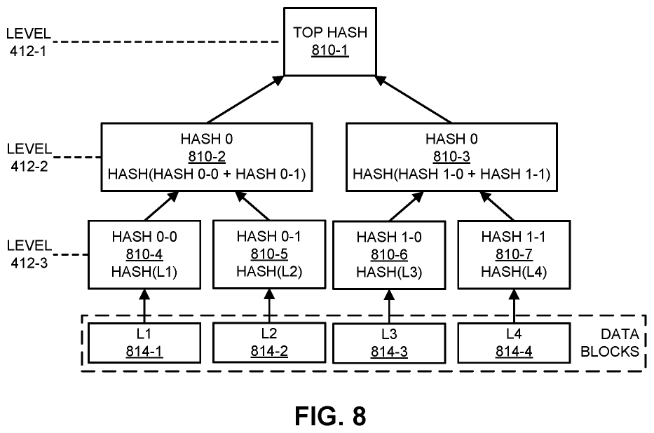

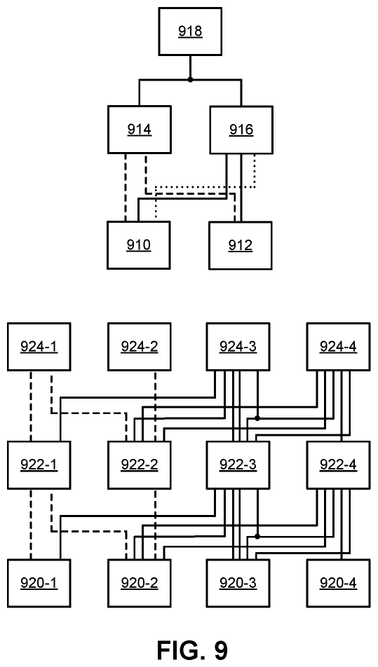

In the tree structure in an MT, every leaf node may be labelled with the cryptographic hash of a data block, while every non-leaf node may be labelled with the cryptographic hash of the labels of its child notes. MTs are generally used to verify data stored, handled and/or transferred between computers, and more specifically, in distribution systems for efficient data verification. FIG. 8 presents a drawing illustrating an example of a binary MT. The general solution also looks like an MT in which a hash (such as one of hash functions 810) for a given node is a convolution of multiple functions of the characteristics of the previous level of the tree (such as one of levels 812) for different data blocks 814. The sequence of the input functions may impact the convolution, such that the convolution itself may be indicative of the sequence. For example, we can read the sequence from the resulting code, and any change in the sequence (or any other input function characteristics) may result in a different code. The choice of functions used to build the codes at every level is part of this disclosure and may provide the unique results. It is described further below.

### Generating the Data Structure

In FIG. 9, which presents a drawing illustrating examples of generalized tree relational structures, information moving up from the lower levels, or leaves, 910-916 to the top 918 may be combined and redistributed at every level. Alternatively, leaves or nodes 920 may feed leaves or nodes 922, which in turn feed leaves or nodes 924. These are not a binary tree like the one shown in FIG. 8, but a variable-level, size N-tree in which every node can be broken into a variable number of N nodes at the next level, and the breaking is not unique. For example, node f(1, 2, 3 . . . , K−1)=f(1, 2, 3 . . . , N−1, 1)+f(1, 2, 3 . . . , K−1, 2)+f(1, 2, 3 . . . , K−1, 3). Moreover, f(1, 2, 3 . . . , K−2)=f(1, 2, 3 . . . , K−1, 1)+f(1, 2, 3 . . . , K−2, 1)+f(1, 2, 3 . . . , K−2, 7).

Based at least in part on this structure, at every level, multiple nodes that can be repeated makes up the codes in the next level. This means that by reading those codes we know exactly which node in the lower level makes it up. Later in this disclosure we introduce more aspects to this concept.

### MT Mapping

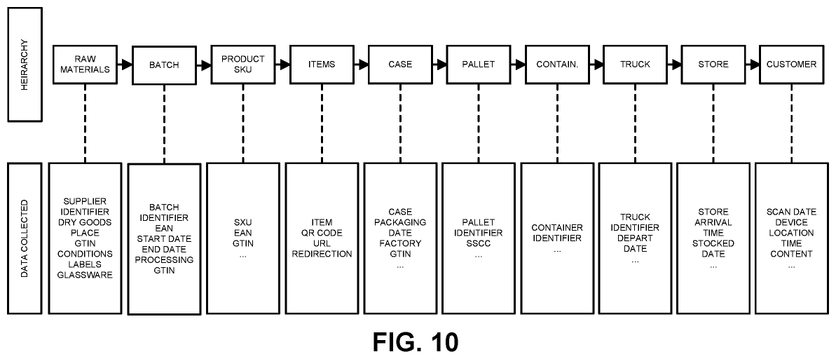

In FIG. 10, which presents a drawing illustrating an example of mapping a problem onto a generalized MT, we see the data being collected at every operation in the process relative to the hierarchical relationships. Left to right, the data collection starts at raw materials and continues throughout the entire supply or fulfillment chain process up until the point that the product reaches the customer. Looking at the data and using existing codes (with the assumption that these codes are unique), we can build a relational data structure or a database that represents every operation. By doing so, we allow for complete traceability in the supply or fulfillment chain, but the data structure mat also aid in the ability to truly verify a product's authenticity using a relational system. However, any changes to contents cannot be verified this way, aka, the problems addressed in the present disclosure. In order to solve these problems, we need to use aggregation at every level.

Note that raw materials in FIG. 10, and materials in general, may have a supplier identifier, location, a GTIN, conditions, labels, glassware or container, and/or other specific information to identify the supply. A batch can have a batch identifier, an EAN, start and end date, processing GTIN, location, environmental information, an identifier of an entity that is performing the processing, and so on. The product stock keeping unit (SKU) can include the SKU, EAN, GTIN, etc. Items can include the item description, a quick response (QR) code, a uniform resource locator (URL) redirection, etc. Moreover, the case may have the case number, packaging date, factory GTIN, etc. Furthermore, the pallet may have information such as the pallet identifier or SSCC. Similarly, the container may have the container identifier. The delivery truck may have a truck identifier, depart date, etc. Additionally, the store may have a store identifier, arrival item, stocked date, etc. The customer may have information, such as the scan date, device used, location, time contents, etc. At every operation, and at every level, we can identify multiple elements that makes up this operation and the objects within it as unique, from bulk and raw materials, and packaged materials all the way to products and their boxes, including who is performing an activity, and when.

Thus, in some embodiments, the generalized MT may use batch-level codes that are generated in existing supply-chain operations and applied to successive product packaging. In these embodiments, these batch-level codes may be used for authentication. This capability may make the embodiments of the authentication techniques, at least in part, compatible with existing systems.

Note that data structures in the present disclosure may include fewer or more fields, one or more fields may be changed, one or more fields may be moved, a filed may be divided into two or more fields, and/or two or more fields may be combined into a single field.

### The Data Model

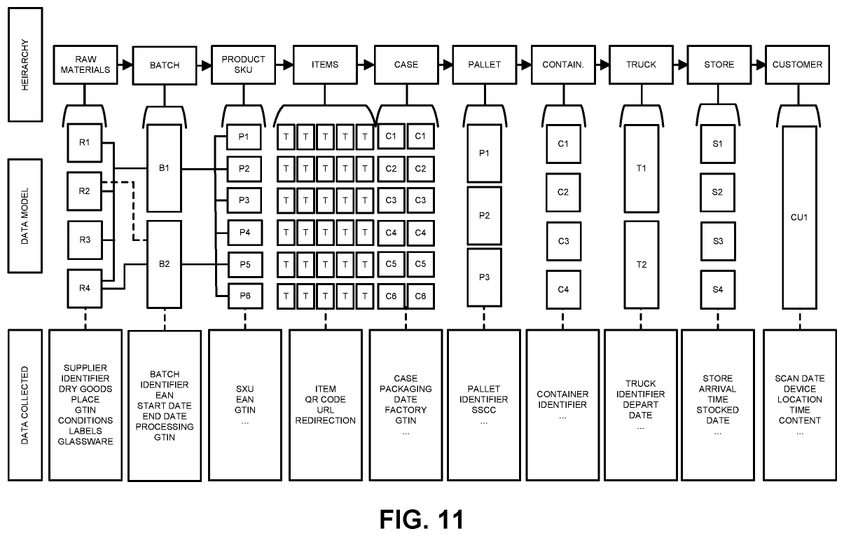

FIG. 11 presents a drawing illustrating an example of a data model as it is being added to the data structure in FIG. 10. Notably, in FIG. 10 we provided some embodiment of information being collected to make up data and codes at each hierarchical operation. In FIG. 11, we make use of this data and add contained objects to container relationships

As shown in FIG. 11, R1-R4 may represent the data collected per raw materials input. In the next level, batches, B1 and B2, could include more batches, but here we use two to represent multiple batches. P1-P6 may represents multiple products that can be marked with a SKU, GTIN, EAN, or other codes or identifiers, and/or separately or additionally time coded with other information. Some products or items in FIG. 11 are marked with T. T may include items, such as: a QR code, a URL redirection, or other information. C1-C6 may represent the cases and may include data such as: the packaging date, factory GTIN, and/or other case identifiers. P1-P3 may represent the pallets used to carry the cases and may include information such as the pallet identifier and SSCC. C1-C4 may represent the containers in which the pallets are stored/shipped and may include information such as the container identifier. T1 and T2 may represent the truck in which the containers are transported in and includes information such as: the truck identifier, departure date and/or other pertinent information for traceability. S1-S4 may represent the stores where the items are distributed and may include information, such as: the store identifier/name, location, arrival time, stocked date, etc. Note that CU1 may represent the customer and data collected, such as: scan date, device, location, time, content, etc.

While the preceding example illustrated the disclosed authentication techniques using particular identifiers, more generally a wide variety of identifiers or codes may be used, such as identifiers that are compatible with or including: GS1 Digital Link, a GTIN, an SSCC, a SGTIN, an EAN, a UPC, an EPC, a GLN, an ISBN, a GRAI, a GCN, an ASIN, a GSIN, a UUID, a GDTY, a GUID, an Eddystone UID or EID, an IMEI, an eSIM identifier, or a PhPID.

### Data Model to Hash Codes

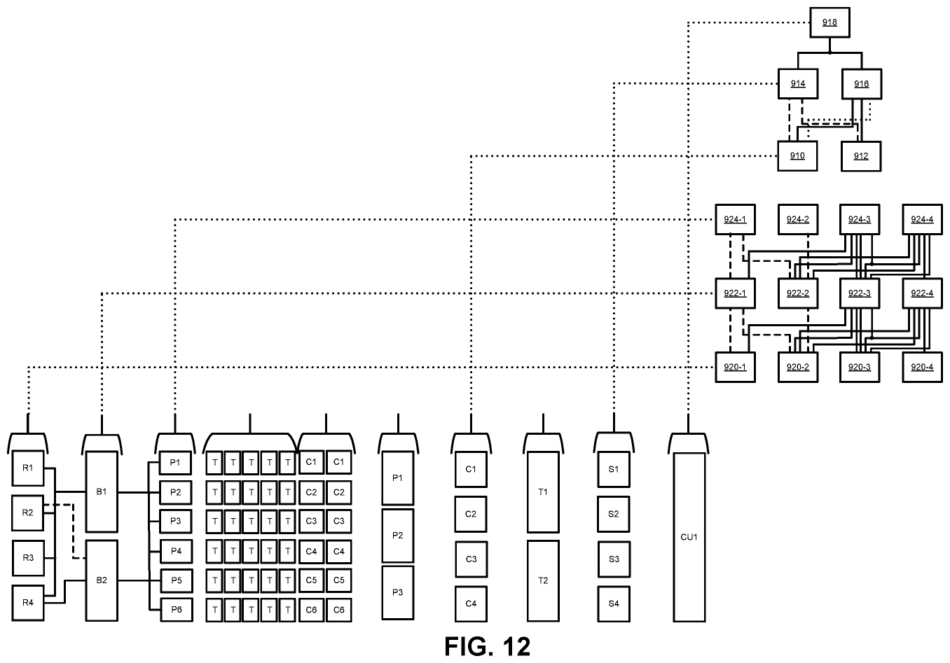

FIG. 12 presents a drawing illustrating an example of a relationship between a data model and hash codes. Notably, FIG. 12 illustrates taking the data model with its unique characteristics and at every layer/level translating it into a generalized MT. As shown below, R1-R4 are mapped to nodes 920. B1 and B2 are mapped to nodes 922, P1-P6 are mapped to nodes 924, C1-C4 are mapped to nodes 910 and 912, S1-S4 are mapped to nodes 914 and 916, and CU1 is mapped to node 918.

Note that subsets of the levels can be subdivided into parts and part of the upper level. For example, a raw material is in nodes 920-1, 920-2 and 920-3. If this raw material is part of node 922-4, then it may have the codes from 920-1, 920-2 and 920-3 recorded as part of its codes. In FIG. 12, noted that there can be many more mapping connections rather than just those shown. Nodes 910-924 are an abstraction level. They do not have to include one-to-connections. Instead, there may be many more that are not shown in FIG. 12. Instead, FIG. 12 is an illustrative example of how the mapping occurs.

FIG. 12 illustrates taking the data model with its unique characteristics and at every layer or level translating it into a generalized MT. The following unique behavior is part of this model: some or all of the elements at a given level can use some unique characteristics to create a data model to manage the process via a cloud-based, distributed or local computer-based data structure; some or all of the elements at a given level can use some unique characteristics to create a unique hash; we use this unique hash to create the next level above with any combination of the level below with addition of unique features that belong to the element above; and/or in absence of uniqueness, we may add a unique code generated in the cloud, locally, and/or in a distributed system.

With these characteristics, we have created an N-level MT, such that each level and each element in each level knows which of the elements below it is part of its makeup, as well it has its own unique identity. In order to enforce authentication that is hard or impossible to forge, we may add additional capabilities or characteristics: sequencing and ordering of elements from the previous level into the current element; quantities in addition to the sequencing and the ordering; ratios, e.g., a percentage of the quantities based at least in part on sequencing in the correct order; physics (e.g., shape, dimensions, color, hue, etc.); temperature and/or environmental; chemistry-based; biology-based; an intended distribution path that is taken from the distribution channel or path; an intended reaggregation and disaggregation operations in the process; and/or an intended target consumer, e.g., the client or the final destination.

Note that we do not limit the implementation to any of the preceding techniques. The MT as representation of a single or multiple codes may be stored on a cloud-based computer, distributed system, local computer, distributed database, a ledger and/or on the objects or container at any level. Also, note that the preceding embodiments are examples that can be many levels deeper or as shallow as needed by the implementation.

Furthermore, once we use this model, during the disaggregation operations we can verify that the unit that is scanned at operation S is part of the aggregate scanned at operation S-1. Now, using this approach, two-level checks (e.g., a check that the item in is the right box) is already helpful, and with additional scanned/coded information we increase the level of confidence in authenticity.

Additionally, note that the more we disaggregate and verify, the more certainty we gain for item or product authenticity. Therefore, multiple levels of disaggregation and verification may result is increased certainty.

When using the MT, it may be sufficient to get a high level of confidence with at least 2-level (or, more generally, N-level, where N is an integer) checks to verify a product and its packaging material. For example, the item and the box, because each identifier captures information about the hierarchy. Note that the two checks may be two levels being checked in the MT.

### Aggregation and Activation Technique

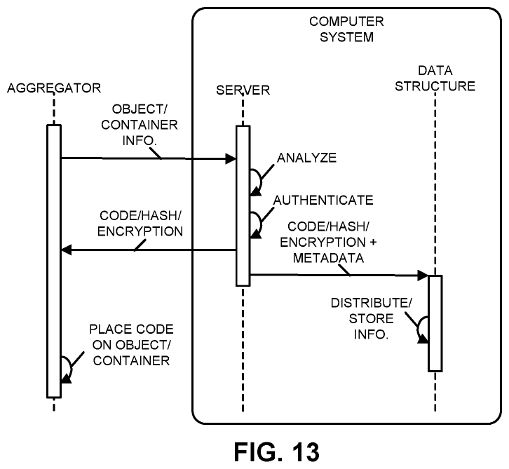

FIG. 13 presents a drawing illustrating an example of an aggregation activation technique. Notably, FIG. 13 illustrates the scanning of information to the computer or server/cloud side. As shown, when a scan occurs, information may be sent to a server (local, cloud-based and/or distributed), where it is then analyzed, authenticated, and a code/hash/encryption is sent back to the scanning authority. This code/hash/encryption and metadata may also be sent to the database or data structure and may be used for further tracking and metadata management and distributed/stored. Note that the operations may include printing or attaching the code on the container. This code can be MT-based or any other code using the methods/technique of choice. Moreover, the hierarchical-contained relationships can be described in a single aggregated hash code or in metadata that a code is pointing to. However, the present disclosure is not limited to these embodiments, but allows different techniques to co-exist or one or the other to be used.

In FIG. 13, operations are recursively processed at every level of the hierarchy, where information is being scanned and sent to the computer (local, cloud-based and/or distributed) for analysis and generation of the next-level hash, which in turn is being captured on the container or box. In any of these embodiments, e.g., when using a code that is MT-hash based, a code that represents metadata or other data structures, etc., the code on the box may be encrypted. This means that, when the code is data pointing into the database or data structure, it is detached from the content it represents for the casual observer. On the other end, if the code is based at least in part on a MT-hash or any other hash, it may be encrypted/signed by the authentication authority and may be indecipherable to anyone else and yet fully related to the content in a way that is non-fungible.

In other embodiments, the act of authentication can be done locally to the code reader/local device, after receiving some support from a computer (local, cloud-based and/or distributed) that can access the metadata.

In some embodiments, sufficient metadata relationship information may be captured in the encrypted code. Therefore, the scanning process may not involve any external computer in order to authenticate a product.

In other embodiments, there may be sets of directions that are provided by the computer, or derived locally, that direct the scanning authority for specific actions or activities to expose more information about the scanned item in order to facilitate accurately authentication.

### Disaggregation Using Codes, Content, and Other Information

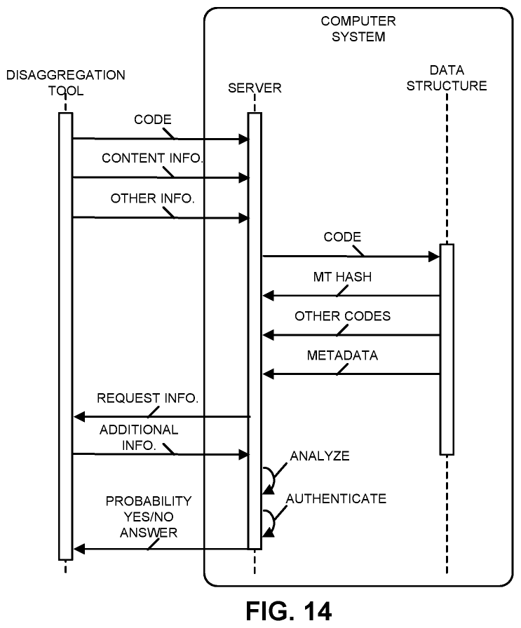

FIG. 14 presents a drawing illustrating an example of a disaggregation technique using codes, content and/or other information. Notably, FIG. 14 illustrates a disaggregation process using a code, content and/or other information sent to a computer or server/cloud side. As shown, the code, or the content, and/or other information may be sent to the computer or server (local, cloud-based and/or distributed). The code from the computer or server may be sent to the database of data structure and in return a MT hash, other codes, and/or metadata may be sent back to the computer or server. Requested information may be sent to a tool (such as software or an application executed in an environment on an electronic device) and additional information may be sent back to the computer or server, which is then analyzed and authenticated, and a final authenticity probability (corresponding to yes or no) may be returned.

The codes or identifiers may be printed codes on the container, and may be contained as captured during the aggregation process. When the disaggregation process is code-only based, codes for content may be provided. Disaggregation can also be based at least in part on other information and codes, e.g., the code for the container may be provided and other information such as the image of the content may also provided. The tool may be directed to provide more information, which it may or may not perform. Note that other information can be environmental or distribution channel information.

Recall that these codes were created or collected during the aggregation operations. Thus, during the disaggregation process, the tool may provide a scanned code of some or all of the included items inside a container, as well as the outside code. The computer or server can use the data structure or database to make sure that the content matches its expectations. Because this process is performed recursively at multiple contained containers, highly accurate results may be obtained.

The analysis operation may perform one or more of the following: generate a code based at least in part on the data and see how close or far it is (such as a Euclidean distance) from the original code; use the data to compare with existing metadata; and/or use the other data to compare to an expected distribution channel status and/or environmental expectations. These operations may be repeated recursively for one or more of the container levels.

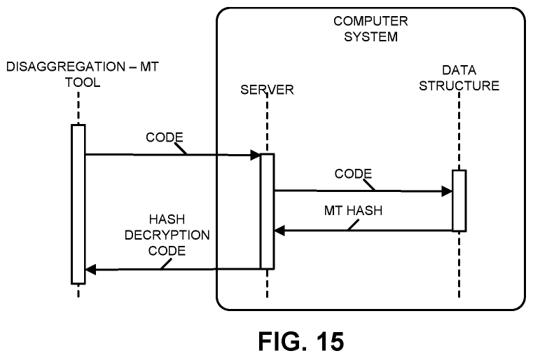

FIG. 15 presents a drawing illustrating an example of a disaggregation technique using an MT hash to unravel content dependencies. Notably, FIG. 15 shows the same process as in FIG. 14 (disaggregation), but in this case there is no need to access the computer or server (local, cloud-based and/or distributed) recursively at every level and operation. Instead, the computer or server may be accessed once (one time) during the process to collect the root code and decryption keys representing the branch or the entire tree. This root code and decryption keys may be an MT hash or MT (concept)-like hash, where the root code contains all inner dependent information and using the decryption keys all codes can be opened. Because an MT hash or MT-like hash may include all the contained codes for every level, it may allow for local authentication with no need to subsequently go back to the computer or server. It is important to note that we only need to capture the root code and encryption codes in order to verify/authenticate. It can be a single key or all the encryption keys for all the levels of the tree (assuming they are different). In addition, in some embodiments there may be a single encryption key for the entire tree. Moreover, in some embodiments, for maximum security, there may be a unique encryption code for each hash (and, thus, multiple encryption keys). Consequently, in some embodiments, each of the keys may be a different random input.

In other embodiments, we can say that as long as the root is acquired from a trusted source, the rest of the information, branch or tree of information can be acquired from any source. At the same time, we assume that you have a leaf in the data structure in front of you that you have scanned.

Furthermore, the hash may include not only contained codes, but other information such as: distribution channel, environmental expectations or information, physics-based, chemistry-based, and/or biological-based information. Some or all of these can be used to trigger positive or negative authentication results without resulting in access to the computer or server.

The following discussion provides an example for selected embodiments depicted in previous sections.

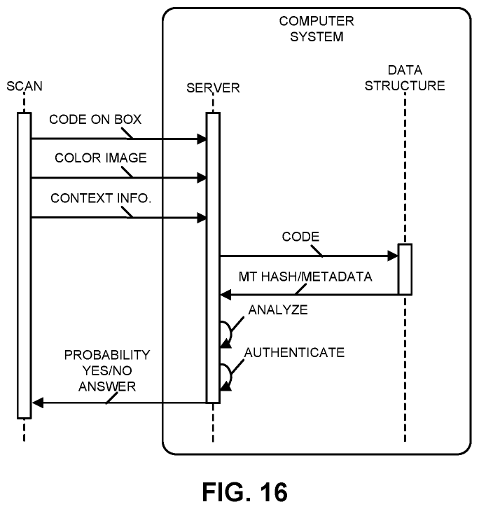

FIG. 16 presents a drawing illustrating an example of scanning and authentication based at least in part on box code, color image and/or context information. Notably, FIG. 16 illustrates embodiments in which a box code may be scanned and the content of the box is imaged. More specifically, the box code may be scanned, and then may be sent to the computer or server (local, cloud-based and/or distributed) with the content information. A code may then be sent to the data structure or database, and MT/metadata may be sent back to the computer or server, where it is analyzed and authenticated. An authentication probability corresponding to ‘yes’ or ‘no’ may be produced.

In some embodiments, content imaging is supplemented with context information, including environmental and/or other localization information that adds more meaning to the image.

Using an image of the content, the computer or server (local, cloud-based and/or distributed) may deploy or use a variety of analysis techniques. In some embodiment, the analysis techniques may be the same as (or are similar to) the one used to generate the code during the aggregation process. In other embodiments, different analysis techniques are used. For example, counting and sequencing was used during aggregation with pictures captured during aggregation process, while during authenticating we can use other information such as orientation and/or colors, or codes featured on the contained objects.

In some embodiments, that aggregation process may provide more data that is used to generate the code that is captured on the box. This data is part of the local computer, cloud-based computer and/or distributed-system metadata associated with this specific code, and may be used at any time in the process to further the knowledge about the object/contained object being authenticated.

The splitting of information between the hash code on the object and the metadata in a local computer, cloud-based computer and/or distributed system may allow for rapid authentication locally without resorting to connecting to the local computer, cloud-based computer and/or distributed system, and also for a more accurate authentication when connecting the computer, cloud-based computer and/or distributed system.

In some embodiments, a similar process to that described for FIG. 14 is used. Notably, rather than content imaging, context information may be sent to the computer or server and data structure or database, which is in turn influences the authentication process. Context information may include data captured, but also the context of this data capturing. The context may be unique at disaggregation time and may be captured (e.g., based at least in part on an expected or planned rout, location, environmental information and/or time) for the aggregated objects using the codes, and may be part of the aggregation formula used to generate the codes and metadata. Context information may add an authentication vector to the authentication techniques to increase accuracy.

Alternatively or additionally, a color image may be used to capture the color ratio that is included in an image. For example, when using raw materials in a mixture, a high-resolution color image may resolve the ratio of the different elements in the mixture. This ratio or color hue may authenticate the mixture relative to the box and the code (hash) on it as unique.

In some embodiments, the number of different colored objects may be counted, such as pills on a table outside a scanned box, candies outside a box, etc. The number may be statistically correct and identified. This gives us one more vector(s) in our authenticity analysis.

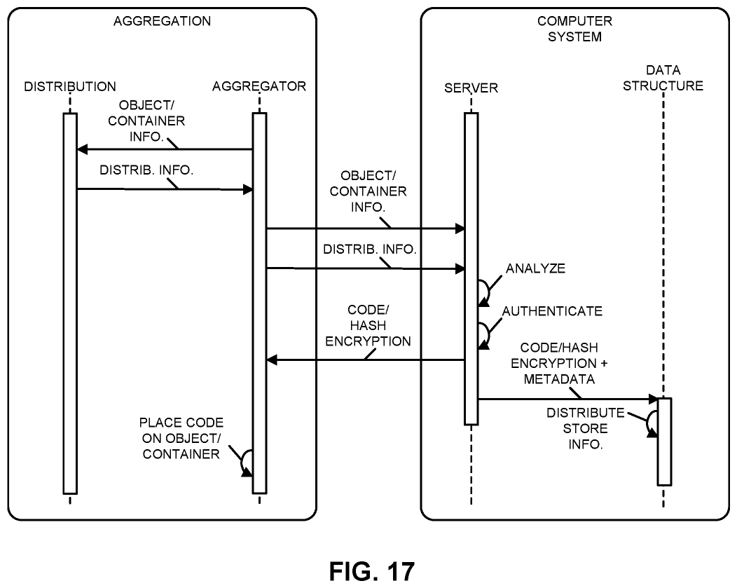

In FIG. 17, which presents a drawing illustrating an example of an aggregation and distribution technique, aggregation that includes distribution information may be generated dynamically (e.g., on the fly or in real time) with access to a computer or server (local, cloud-based and/or distributed) that includes distribution information. The distribution computer or server in this case may be replaced by another computer or server that contains unique information that may change dynamically prior to closing a box or a container or an object during the aggregation process. In some embodiments, object/container information may be sent from the aggregator to the distribution, and distribution information may be sent back. The object/container information and distribution information may be sent to the computer or server, analyzed and authenticated, and a code/hash/encryption may be sent back to the aggregator. The code/hash/encryption and metadata may also be sent to the data structure or database, which may distribute/store the information. Furthermore, a code may be placed on the object/container as a result of the above process. This information may add to the metadata, to the hash code and/or to the MT hash, such that it adds to the accuracy and ability to authenticate, and may also facilitate controlled distribution and localization based at least in part on the codes.

### Container Within a Container

Container within a container provides understanding and authenticating of a product based at least in part on any container in which it is include in a supply or fulfillment chain. From raw materials, to batch, to pallet, to box, one should be able to authenticate the product anywhere along the supply or fulfillment chain and/or also use information from previous containers for authentication purposes. Note that every element at every level can use some unique characteristics to create a traceable data model.

Moreover, the authentication techniques may be MT-based. As discussed previously, MT may provide a generalized tree relational structure, where information moving up from the lower levels, or leaves, may be combined and redistributed at every level. This may not be a binary tree like the one shown in FIG. 8, but may be a variable-level, size-N tree in which every node can be broken into a variable number of N nodes at the next level. In some embodiments, the subdividing may not be unique.

Based at least in part on this data structure, at every level, multiple nodes (that can be repeated) may make up the codes in the next level. This means that by reading those codes, we may know exactly which node in the lower level(s) are below the current level.

Taking the data model with its unique characteristics, at every layer or level it may be translated into a generalized MT. The following unique behaviors may be part of this data model: one or more elements at one or more levels may use one or more unique characteristics to create a data model to manage the process via a local, cloud-based and/or distributed data structure or database; one or more elements at one or more levels may use one or more unique characteristics to create a unique hash; we may use this unique hash to create the next level above it with a wide variety of combinations of the level(s) below it with the addition of one or more unique features that belong to the one or more elements above it; and/or in the absence of uniqueness, we may add or use a unique code generated locally, in the cloud and/or in a distributed system. In these ways, we may create an N-level MT, such that one or more levels and one or more elements in the one or more levels knows which of the one or more elements below it is part of its makeup, as well it has its own unique identity.

### Dynamic Information From Distribution Channels

The complicated relationships within the supply or fulfillment chain for a given product and process provide an independent behavioral-based measurement of uniqueness relative to the subject or object that is being assessed for authenticity. This may include creating the data (e.g., no longer based at least in part on what we see as content), such as using dynamic information that comes from the distribution channel or target client. For example, the dynamic information may include: where does it go (such as a target path); information that is independent from the product/comes from an external source; can be performed in the metadata or the codes themselves; and/or when using the codes and disaggregation, we can identify the information with or without accessing the computer or server.

### Embodiments

We now describe several groups of embodiments. In a first group of embodiments, a system for authentication may be based in part on the contained objects/parts in a box/container/whole. In embodiments the inclusion of objects into the container may be based at least in part on multiple information dimensions, e.g. a multiple repetitions of: multiple boxes/objects within multiple addition boxes/objects, etc. The complicated relationships within a given product and process may provide an independent behavioral-based measurement of uniqueness relative to the subject that can be assessed for authenticity and used in the authentication process. Moreover, the authentication techniques may use one or more of the following when inserting multiple objects into multiple packages: count; mark (color); sign; add random noise or information to an object before combining into a whole or before inserted into a box; use information, related and unrelated to, the object/objects included in a box; sequencing and order information (such as sequencing and ordering of elements from the previous level into the current element, and/or ratios, e.g., a percentage of quantities based at least in part on sequencing in the correct order); measurements associated with physics of the multiple inserted objects; measurements associated with chemistry of the multiple inserted objects; measurements associated with the biological makeup; measurable quantitative and/or qualitative information associated with the inserted objects (such as one or more dimensions of an object); a probability and/or another mathematical function based at least in part on or related to the multiple inserted objects, environment; a measured probability depending on physics or chemistry (such as the hue generated by multiple colors, and/or molecular/atomic measurement); use the insertion process to create a unique and combined identity that informs outside of the box about the content and use the sequence/placements/randomness as a key to uniquely authenticate the box and/or an object in the box; create a digital identity composed of some of all of the operations information; create a digital identity composed of some or all of the operations information processed by an analysis technique that generates uniqueness that is discoverable independent of the digital identity; an intended distribution path that is taken from a distribution channel or path; intended reaggregation and disaggregation operations in a fulfillment process; and an intended target customer, e.g., a client or the final destination.

In a second group of embodiments, an MT is used to represent the relationships between contained hierarchical objects. For example, the system may use and/or print MT hashes on packages creating an offline solution for capturing MT structure. Moreover, one or more elements at one or more levels may use one or more unique characteristics to create a data model to manage the authentication process via a local, cloud-based and/or distributed data structure or database. Note that one or more elements at one or more levels may use one or more unique characteristics to create a unique hash. This unique hash may be used to create the next level above with an arbitrary combination of the level below and/or with the addition of unique features that belong to the element above it. In the absence of uniqueness, we may add a unique code generated locally, in the cloud and/or in a distributed system. Furthermore, the system may use an N-level MT, such that a given level and a given element in the given level may know its elemental makeup and may have its own unique identity. In some embodiments, when using an MT, a high level of confidence may be obtained with 2-level checks (e.g. about an item and or box, because each identifier may capture sufficient information about the hierarchy) to verify authenticity. In general, the MT may provide a compressed version of multiple if/then inputs. Additionally, when a hash is created, a public code performing the disaggregation may be included. In some embodiments as long as the root is acquired from a trusted source, the rest of the information, branch and/or tree of information may be acquired from an arbitrary source.

In a third group of embodiments, dynamic information may be obtained from distribution channels. Notably, scanning information may be sent to a local computer or server, a cloud-based computer or server and/or a distributed system where it is then analyzed, authenticated and a code/hash/encryption may be sent back to the scanning authority. In some embodiments, operations may be recursively processed at one or more levels of the hierarchy, where information is being scanned and sent to a local computer or server, a cloud-based computer or server and/or a distributed system for analysis and generation of the next level hash, which in turn is captured or printed on the container or box. As noted, authentication may be performed locally to the code reader or local device, after receiving some support from a local computer or server, a cloud-based computer or server and/or a distributed system, which can access the metadata. Moreover, authentication may occur when sufficient metadata relationship information is captured in the encrypted code, such that the scanning process does not involve an external computer or server in order to authenticate a product.

Furthermore, a set of directions may provided by the computer or server, or derived locally, that direct the scanning authority, for specific operations to expose more information about the scanned item in order to further accurately authenticate it. Alternatively or additionally, a set of directions may be provided by the computer or server, or derived locally, that direct the scanning authority for specific activities to expose more information about the scanned item in order to further accurately authenticate it.

In some embodiments, the analysis operations may include one or more of: generating a code based at least in part on the data and to see how close or far it is from the original code; using the data to compare with existing metadata; and/or using the other data to compare to expected distribution channel status and/or environmental expectations. Moreover, the preceding operations may be repeated recursively for one or more container level.

Note that the system may not need to access the computer or server (local, cloud-based and/or distributed) recursively at one or more level and operation, but only once (one time) during the process to collect the root code and decryption keys. This root code and decryption keys may be an MT hash or MT (concept)-like hash, where the root code may include all inner dependent information and using the decryption keys all the codes can be decrypted. Because an MT hash or MT-like hash may include all the contained codes for one or more levels, it may allow for local authentication with no need to go back to the computer or server at any time afterwards.

Moreover, an aggregation process that includes distribution information may be generated in real time with access to a computer or server (local, cloud-based and/or distributed) that includes distribution information. The distribution computer or server in these embodiments may be replaced by another computer or server that contains unique information that may change dynamically prior to closing a box, a container or an object during the aggregation process.

In some embodiments, object/container information may be sent from the aggregator to the distribution and the distribution information may be sent back. Furthermore, the object/container information and distribution information may be analyzed and authenticated, and a code/hash/encryption may be generated and the generated encryption and/or metadata may be shared with the data structure or database.

Note that a product of this process may be a code that is placed or printed on the object/container. This information may add to the metadata, to the hash code and/or to the MT hash, such that it adds to the accuracy and the ability to authenticate and/or control distribution and localization based at least in part on the codes.

We now describe embodiments of an electronic device, which may perform at least some of the operations in the authentication techniques. FIG. 18 presents a block diagram illustrating an example of an electronic device 1800 in accordance with some embodiments, such as electronic device 110, electronic device 112, access point 114, base station 116, one of computers 120, etc. This electronic device includes processing subsystem 1810, memory subsystem 1812, and networking subsystem 1814. Processing subsystem 1810 includes one or more devices configured to perform computational operations. For example, processing subsystem 1810 can include one or more microprocessors, ASICs, microcontrollers, programmable-logic devices, one or more graphics process units (GPUs) and/or one or more digital signal processors (DSPs).

Memory subsystem 1812 includes one or more devices for storing data and/or instructions for processing subsystem 1810 and networking subsystem 1814. For example, memory subsystem 1812 can include dynamic random access memory (DRAM), static random access memory (SRAM), and/or other types of memory. In some embodiments, instructions for processing subsystem 1810 in memory subsystem 1812 include: one or more program modules or sets of instructions (such as program instructions 1822 or operating system 1824), which may be executed by processing subsystem 1810. Note that the one or more computer programs may constitute a computer-program mechanism. Moreover, instructions in the various modules in memory subsystem 1812 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 1810.

In addition, memory subsystem 1812 can include mechanisms for controlling access to the memory. In some embodiments, memory subsystem 1812 includes a memory hierarchy that comprises one or more caches coupled to a memory in electronic device 1800. In some of these embodiments, one or more of the caches is located in processing subsystem 1810.

In some embodiments, memory subsystem 1812 is coupled to one or more high-capacity mass-storage devices (not shown). For example, memory subsystem 1812 can be coupled to a magnetic or optical drive, a solid-state drive, or another type of mass-storage device. In these embodiments, memory subsystem 1812 can be used by electronic device 1800 as fast-access storage for often-used data, while the mass-storage device is used to store less frequently used data.

Networking subsystem 1814 includes one or more devices configured to couple to and communicate on a wired and/or wireless network (i.e., to perform network operations), including: control logic 1816, an interface circuit 1818 and one or more antennas 1820 (or antenna elements) and/or input/output (I/O) port 1830. (While FIG. 18 includes one or more antennas 1820, in some embodiments electronic device 1800 includes one or more nodes, such as nodes 1808, e.g., a network node that can be coupled or connected to a network or link, or an antenna node or a pad that can be coupled to the one or more antennas 1820. Thus, electronic device 1800 may or may not include the one or more antennas 1820.) For example, networking subsystem 1814 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, a cable modem networking system, and/or another networking system.

Networking subsystem 1814 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1800 may use the mechanisms in networking subsystem 1814 for performing simple wireless communication between the electronic devices, e.g., transmitting advertising or beacon frames and/or scanning for advertising frames transmitted by other electronic devices as described previously.

Within electronic device 1800, processing subsystem 1810, memory subsystem 1812, and networking subsystem 1814 are coupled together using bus 1828. Bus 1828 may include an electrical, optical, and/or electro-optical connection that the subsystems can use to communicate commands and data among one another. Although only one bus 1828 is shown for clarity, different embodiments can include a different number or configuration of electrical, optical, and/or electro-optical connections among the subsystems.

In some embodiments, electronic device 1800 includes a display subsystem 1826 for displaying information on a display, which may include a display driver and the display, such as a liquid-crystal display, a multi-touch touchscreen, etc.

Electronic device 1800 can be (or can be included in) any electronic device with at least one network interface. For example, electronic device 1800 can be (or can be included in): a computer system (such as a cloud-based computer system or a distributed computer system), a desktop computer, a laptop computer, a subnotebook/netbook, a server, a tablet computer, a smartphone, a cellular telephone, a smartwatch, a consumer-electronic device, a portable computing device, an access point, a transceiver, a router, a switch, communication equipment, a computer network device, a stack of computer network devices, a controller, test equipment, a printer, and/or another electronic device.

Although specific components are used to describe electronic device 1800, in alternative embodiments, different components and/or subsystems may be present in electronic device 1800. For example, electronic device 1800 may include one or more additional processing subsystems, memory subsystems, networking subsystems, and/or display subsystems. Additionally, one or more of the subsystems may not be present in electronic device 1800. Moreover, in some embodiments, electronic device 1800 may include one or more additional subsystems that are not shown in FIG. 18, such as a user-interface subsystem 1832. Also, although separate subsystems are shown in FIG. 18, in some embodiments some or all of a given subsystem or component can be integrated into one or more of the other subsystems or component(s) in electronic device 1800. For example, in some embodiments program instructions 1822 are included in operating system 1824 and/or control logic 1816 is included in interface circuit 1818.

Moreover, the circuits and components in electronic device 1800 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 1814 (or, more generally, of electronic device 1800). The integrated circuit may include hardware and/or software mechanisms that are used for transmitting wireless signals from electronic device 1800 and receiving signals at electronic device 1800 from other electronic devices. Aside from the mechanisms herein described, radios are generally known in the art and hence are not described in detail. In general, networking subsystem 1814 and/or the integrated circuit can include any number of radios. Note that the radios in multiple-radio embodiments function in a similar way to the described single-radio embodiments.

In some embodiments, networking subsystem 1814 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Ethernet, a cellular-telephone communication protocol and a Wi-Fi communication protocol as an illustrative example, in other embodiments a wide variety of communication protocols and, more generally, wired and/or wireless communication techniques may be used. Thus, the authentication techniques may be used with a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the authentication techniques may be implemented using program instructions 1822, operating system 1824 (such as a driver for interface circuit 1818) or in firmware in interface circuit 1818. Alternatively or additionally, at least some of the operations in the authentication techniques may be implemented in a physical layer, such as hardware in interface circuit 1818.

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the authentication technique, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with an electronic device;
a processor coupled to the interface circuit; and
memory, coupled to the processor, storing program instructions and a data structure for objects, wherein the data structure comprises, for a given object, authentication information corresponding to hierarchical arrangement of levels or operations in a supply or a fulfillment chain of the given object, wherein, other than terminal levels in the hierarchical arrangement, the authentication information for a given level in the hierarchical arrangement is based at least in part on container or packaging information of containers or packages in at least a subset of levels below the given level in the hierarchical arrangement and second container or packaging information of a given container or a given package in the given level, and wherein, when executed by the processor, the program instructions cause the computer system to perform operations comprising:
receiving, at the interface circuit and associated with the electronic device, an identifier of an object or a label associated with the object;
determining an authentication score of the object based at least in part on the authentication information for a level in the hierarchical arrangement associated with the identifier; and
providing, from the interface circuit and addressed to the electronic device, information that specifies whether the object is authentic based at least in part on the authentication score.

2. The computer system of claim 1, wherein the levels in the hierarchical arrangement correspond to an ordered sequence of operations in the supply or a fulfillment chain, and the subset of levels are prior to the given level in the ordered sequence or subsequent to the given level in the ordered sequence.

3. The computer system of claim 1, wherein the operations comprise:
receiving, at the interface circuit and associated with a second electronic device, update information corresponding to another operation in the ordered sequence of operations; and
dynamically modifying the data structure based at least in part on the update information.

4. The computer system of claim 1, wherein the hierarchical arrangement comprises a Merkle tree with the levels; and
wherein there are M levels and N subsets of levels in the Merkle tree, and M and N are non-zero integers.

5. The computer system of claim 1, wherein given container or packaging information comprises content associated with the given object, a context associated with the given object or both.

6. The computer system of claim 1, wherein given container or packaging information comprises one or more of: a number of instances of the given object in the given container or the given package; an absolute or relative number associated with the given object; physical information associated with the given object; chemical information associated with the given object; biological information associated with the given object; environmental information associated with the given object; or color information associated with the given object.

7. The computer system of claim 1, wherein the authentication information comprises a hash function that uses as inputs the container or packaging information of at least the subset of levels below the given level in the hierarchical arrangement.

8. The computer system of claim 1, wherein the authentication information is encrypted.

9. The computer system of claim 8, wherein different levels in the hierarchical arrangement use different encryption keys.

10. The computer system of claim 1, wherein, for the given level, the authentication information is based at least in part on a customer or intended destination of the given container or the given package.

11. The computer system of claim 1, wherein the identifier is encrypted.

12. The computer system of claim 1, wherein a relationship between the given level and the subset of daughter levels in the hierarchy is not unique to the given object.

13. The computer system of claim 1, wherein the objects comprise products.

14. The computer system of claim 1, wherein the authentication information is unique in the hierarchical arrangement.

15. A method for providing information that specifies whether an object is authentic, comprising:
by a computer system:
receiving, associated with an electronic device, an identifier of an object or a label associated with the object;
determining an authentication score of the object based at least in part on authentication information for the object and corresponding to a level in a hierarchical arrangement of levels or operations in a supply or a fulfillment chain of the object, wherein, other than terminal levels in the hierarchical arrangement, the authentication information for the level in the hierarchical arrangement is based at least in part on container or packaging information of containers or packages in at least a subset of levels below the level in the hierarchical arrangement and second container or packaging information of a given container or a given package in the level; and
providing, addressed to the electronic device, the information that specifies whether the object is authentic based at least in part on the authentication score.

16. The method of claim 15, wherein the levels in the hierarchical arrangement correspond to an ordered sequence of operations in the supply or a fulfillment chain, and the subset of levels are prior to the given level in the ordered sequence or subsequent to the given level in the ordered sequence.

17. The method of claim 15, wherein the hierarchical arrangement comprises a Merkle tree with the levels; and
wherein there are M levels and N subsets of levels in the Merkle tree, and M and N are non-zero integers.

18. An electronic device, comprising:
an interface circuit configured to communicate with a computer system;
a processor coupled to the interface circuit; and
memory, coupled to the processor, storing program instructions, wherein, when executed by the processor, the program instructions cause the computer system to perform operations comprising:
providing, from the interface circuit and addressed to the computer system, an identifier of an object or a label associated with the object; and
receiving, at the interface circuit and associated with the computer system, information that specifies whether the object is authentic based at least in part on an authentication score, wherein the authentication score of the object is based at least in part on authentication information for the object and corresponding to two or more levels in a hierarchical arrangement of levels or operations in a supply or a fulfillment chain of the object, and
wherein the authentication information is based at least in part on container or packaging information of containers or packages in at least a subset of levels below a current level in the hierarchical arrangement and second container or packaging information of a given container or a given package in the current level.

19. The electronic device of claim 18, wherein, for the current level, the authentication information is based at least in part on a customer or intended destination of the given container or the given package.

20. The electronic device of claim 18, wherein the identifier is encrypted.
